(19) United States
(12) Patent Application Publication
(10) Pub. No.: US 2012/0255296 A1
(43) Pub. Date: Oct. 11, 2012

(54) AIR MANAGEMENT SYSTEM FOR AIR HYBRID ENGINE

(75) Inventors: Ford A. Phillips, San Antonio, TX (US); Riccardo Meldolesi, East Sussex (GB); Nicholas Badain, West Sussex (GB); Ian P. Gilbert, West Sussex (GB); Jean-Pierre Pirault, West Sussex (GB)

(73) Assignee: SCUDERI GROUP, LLC, 01089, MA (US)

(21) Appl. No.: 13/441,023

(22) Filed: Apr. 6, 2012

Related U.S. Application Data
(60) Provisional application No. 61/595,285, filed on Feb. 6, 2012.
(60) Provisional application No. 61/473,306, filed on Apr. 8, 2011.

(51) Int. Cl. F02G 1/043

(52) U.S. Cl. 60/526; 60/517

(57) ABSTRACT

Systems and related methods are disclosed that generally involve adjusting the temperature of an air mass to improve the efficiency of an air hybrid engine. In one embodiment, an air management system is provided that includes a heat exchanger, a recuperator, and associated control valves that connect between the air hybrid engine, its exhaust system, and its air tank. The air management system improves the efficiency of the energy transfer to the air tank by compressed air during AC and FC modes and improves the efficiency of the energy transfer from the air tank by compressed air during AE and AEF modes. The improvement in efficiency from the system results in reduced engine and vehicle fuel consumption during driving cycles comprising accelerations, decelerations, and steady-state cruising.

### CROSS-REFERENCE TO RELATED APPLICATIONS

This application claims the benefit of priority of U.S. Provisional Patent Application Number 61/473,306, filed on Apr. 8, 2011, the entire contents of which are incorporated herein by reference. This application also claims the benefit of priority of U.S. Provisional Patent Application Number 61/595,285, filed on Feb. 6, 2012, the entire contents of which are incorporated herein by reference.

### FIELD

The present invention relates to air management systems. More particularly, the invention relates to air management systems for air hybrid engines.

### BACKGROUND

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (“CA”)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine generally comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

A split-cycle air hybrid engine combines a split-cycle engine with an air reservoir (also commonly referred to as an air tank) and various controls. This combination enables the engine to store energy in the form of compressed air in the air reservoir. The compressed air in the air reservoir is later used in the expansion cylinder to power the crankshaft. In general, a split-cycle air hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

FIG. 1 illustrates one exemplary embodiment of a prior art split-cycle air hybrid engine. The split-cycle engine 100 replaces two adjacent cylinders of a conventional engine with a combination of one compression cylinder 102 and one expansion cylinder 104. The compression cylinder 102 and the expansion cylinder 104 are formed in an engine block in which a crankshaft 106 is rotatably mounted. Upper ends of the cylinders 102, 104 are closed by a cylinder head 130. The crankshaft 106 includes axially displaced and angularly offset first and second crank throws 126, 128, having a phase angle therebetween. The first crank throw 126 is pivotally joined by a first connecting rod 138 to a compression piston 110 and the second crank throw 128 is pivotally joined by a second connecting rod 140 to an expansion piston 120 to reciprocate the pistons 110, 120 in their respective cylinders 102, 104 in a timed relation determined by the angular offset of the crank throws and the geometric relationships of the cylinders, crank, and pistons. Alternative mechanisms for relating the motion and timing of the pistons can be utilized if desired. The rotational direction of the crankshaft and the relative motions of the pistons near their bottom dead center (BDC) positions are indicated by the arrows associated in the drawings with their corresponding components.

The four strokes of the Otto cycle are thus “split” over the two cylinders 102 and 104 such that the compression cylinder 102 contains the intake and compression strokes and the expansion cylinder 104 contains the expansion and exhaust strokes. The Otto cycle is therefore completed in these two cylinders 102, 104 once per crankshaft 106 revolution (360 degrees CA).

During the intake stroke, intake air is drawn into the compression cylinder 102 through an inwardly-opening (opening inward into the cylinder and toward the piston) poppet intake valve 108. During the compression stroke, a compression piston 110 pressurizes the air charge and drives the air charge through a crossover passage 112, which acts as the intake passage for the expansion cylinder 104. The engine 100 can have one or more crossover passages 112.

The volumetric (or geometric) compression ratio of the compression cylinder 102 of the split-cycle engine 100 (and for split-cycle engines in general) is herein referred to as the “compression ratio” of the split-cycle engine. The volumetric (or geometric) compression ratio of the expansion cylinder 104 of the engine 100 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its bottom dead center (BDC) position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high volumetric compression ratios (e.g., 20 to 1, 30 to 1, 40 to 1, or greater) within the compression cylinder 102, an outwardly-opening (opening outwardly away from the cylinder and piston) poppet crossover compression (XovrC) valve 114 at the inlet of the crossover passage 112 is used to control flow from the compression cylinder 102 into the crossover passage 112. Due to very high volumetric compression ratios (e.g., 20 to 1, 30 to 1, 40 to 1, or greater) within the expansion cylinder 104, an outwardly-opening poppet crossover expansion (XovrE) valve 116 at the outlet of the crossover passage 112 controls flow from the crossover passage 112 into the expansion cylinder 104. The actuation rates and phasing of the XovrC and XovrE valves 114, 116 are timed to maintain pressure in the crossover passage 112 at a high minimum pressure (typically 20 bar or higher at full load) during all four strokes of the Otto cycle.

At least one fuel injector 118 injects fuel into the pressurized air at the exit end of the crossover passage 112 in coordination with the XovrE valve 116 opening. Alternatively, or in addition, fuel can be injected directly into the expansion cylinder 104. The fuel-air charge fully enters the expansion cylinder 104 shortly after the expansion piston 120 reaches its top dead center (“TDC”) position. As the piston 120 begins its descent from its TDC position, and while the XovrE valve 116 is still open, one or more spark plugs 122 are fired to initiate combustion (typically between 10 to 20 degrees CA after TDC of the expansion piston 120). Combustion can be initiated while the expansion piston is between 1 and 30 degrees CA past its TDC position. More preferably, combustion can be initiated while the expansion piston is between 5 and 25 degrees CA past its TDC position. Most preferably, combustion can be initiated while the expansion piston is between 10 and 20 degrees CA past its TDC position. Additionally, combustion can be initiated through other ignition devices and/or methods, such as with glow plugs, microwave ignition devices, or through compression ignition methods.

The XovrE valve 116 is then closed before the resulting combustion event enters the crossover passage 112. The combustion event drives the expansion piston 120 downward in a power stroke. Exhaust gases are pumped out of the expansion cylinder 104 through an inwardly-opening poppet exhaust valve 124 during the exhaust stroke.

With the split-cycle engine concept, the geometric engine parameters (i.e., bore, stroke, connecting rod length, compression ratio, etc.) of the compression and expansion cylinders are generally independent from one another. For example, the crank throws 126, 128 for the compression cylinder 102 and expansion cylinder 104, respectively, have different radii and are phased apart from one another with TDC of the expansion piston 120 occurring prior to TDC of the compression piston 110. This independence enables the split-cycle engine to potentially achieve higher efficiency levels and greater torques than typical four-stroke engines.

The geometric independence of engine parameters in the split-cycle engine 100 is also one of the main reasons why pressure can be maintained in the crossover passage 112 as discussed earlier. Specifically, the expansion piston 120 reaches its top dead center position prior to the compression piston 110 reaching its top dead center position by a discrete phase angle (typically between 10 and 30 crank angle degrees). This phase angle, together with proper timing of the XovrC valve 114 and the XovrE valve 116, enables the split-cycle engine 100 to maintain pressure in the crossover passage 112 at a high minimum pressure (typically 20 bar absolute or higher during full load operation) during all four strokes of its pressure/volume cycle. That is, the split-cycle engine 100 is operable to time the XovrC valve 114 and the XovrE valve 116 such that the XovrC and XovrE valves 114, 116 are both open for a substantial period of time (or period of crankshaft rotation) during which the expansion piston 120 descends from its TDC position towards its BDC position and the compression piston 110 simultaneously ascends from its BDC position towards its TDC position. During the period of time (or crankshaft rotation) that the crossover valves 114, 116 are both open, a substantially equal mass of gas is transferred (1) from the compression cylinder 102 into the crossover passage 112 and (2) from the crossover passage 112 to the expansion cylinder 104. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 114 and XovrE valve 116 are both closed to maintain the mass of trapped gas in the crossover passage 112 at a substantially constant level. As a result, the pressure in the crossover passage 112 is maintained at a predetermined minimum pressure during all four strokes of the engine's pressure/volume cycle.

For purposes herein, the method of opening the XovrC 114 and XovrE 116 valves while the expansion piston 120 is descending from TDC and the compression piston 110 is ascending toward TDC in order to simultaneously transfer a substantially equal mass of gas into and out of the crossover passage 112 is referred to herein as the “push-pull” method of gas transfer. It is the push-pull method that enables the pressure in the crossover passage 112 of the engine 100 to be maintained at typically 20 bar or higher during all four strokes of the engine's cycle when the engine is operating at full load.

The crossover valves 114, 116 are actuated by a valve train that includes one or more cams (not shown). In general, a cam-driven mechanism includes a camshaft mechanically linked to the crankshaft. One or more cams are mounted to the camshaft, each having a contoured surface that controls the valve lift profile of the valve event (i.e., the event that occurs during a valve actuation). The XovrC valve 114 and the XovrE valve 116 each can have its own respective cam and/or its own respective camshaft. As the XovrC and XovrE cams rotate, eccentric portions thereof impart motion to a rocker arm, which in turn imparts motion to the valve, thereby lifting (opening) the valve off of its valve seat. As the cam continues to rotate, the eccentric portion passes the rocker arm and the valve is allowed to close.

For purposes herein, a valve event (or valve opening event) is defined as the valve lift from its initial opening off of its valve seat to its closing back onto its valve seat versus rotation of the crankshaft during which the valve lift occurs. Also, for purposes herein, the valve event rate (i.e., the valve actuation rate) is the duration in time required for the valve event to occur within a given engine cycle. It is important to note that a valve event is generally only a fraction of the total duration of an engine operating cycle (e.g., 720 degrees CA for a conventional engine cycle and 360 degrees CA for a split-cycle engine).

The split-cycle air hybrid engine 100 also includes an air reservoir (tank) 142, which is operatively connected to the crossover passage 112 by an air reservoir tank valve 152. Embodiments with two or more crossover passages 112 may include a tank valve 152 for each crossover passage 112, which connect to a common air reservoir 142, or alternatively each crossover passage 112 may operatively connect to separate air reservoirs 142.

The tank valve 152 is typically disposed in an air tank port 154, which extends from the crossover passage 112 to the air tank 142. The air tank port 154 is divided into a first air tank port section 156 and a second air tank port section 158. The first air tank port section 156 connects the air tank valve 152 to the crossover passage 112, and the second air tank port section 158 connects the air tank valve 152 to the air tank 142. The volume of the first air tank port section 156 includes the volume of all additional recesses which connect the tank valve 152 to the crossover passage 112 when the tank valve 152 is closed. Preferably, the volume of the first air tank port section 156 is small relative to the second air tank port section 158. More preferably, the first air tank port section 156 is substantially non-existent, that is, the tank valve 152 is most preferably disposed such that it is flush against the outer wall of the crossover passage 112.

The tank valve 152 may be any suitable valve device or system. For example, the tank valve 152 may be a pressure activated check valve, or an active valve which is activated by various valve actuation devices (e.g., pneumatic, hydraulic, cam, electric, or the like). Additionally, the tank valve 152 may comprise a tank valve system with two or more valves actuated with two or more actuation devices.

The air tank 142 is utilized to store energy in the form of compressed air and to later use that compressed air to power the crankshaft 106. This mechanical means for storing potential energy provides numerous potential advantages over the current state of the art. For instance, the split-cycle air hybrid engine 100 can potentially provide many advantages in fuel efficiency gains and NOx emissions reduction at relatively low manufacturing and waste disposal costs in relation to other technologies on the market, such as diesel engines and electric-hybrid systems.

The engine 100 typically runs in a normal operating or firing (NF) mode (also commonly called the engine firing (EF) mode) and one or more of four basic air hybrid modes. In the EF mode, the engine 100 functions normally as previously described in detail herein, operating without the use of the air tank 142. In the EF mode, the air tank valve 152 remains closed to isolate the air tank 142 from the basic split-cycle engine. In the four air hybrid modes, the engine 100 operates with the use of the air tank 142.

The four basic air hybrid modes include:

1) Air Expander (AE) mode, which includes using compressed air energy from the air tank 142 without combustion;

2) Air Compressor (AC) mode, which includes storing compressed air energy into the air tank 142 without combustion;

3) Air Expander and Firing (AEF) mode, which includes using compressed air energy from the air tank 142 with combustion; and

4) Firing and Charging (FC) mode, which includes storing compressed air energy into the air tank 142 with combustion.

Further details on split-cycle engines can be found in U.S. Pat. No. 6,543,225 entitled Split Four Stroke Cycle Internal Combustion Engine and issued on Apr. 8, 2003; and U.S. Pat. No. 6,952,923 entitled Split-Cycle Four-Stroke Engine and issued on Oct. 11, 2005, each of which is incorporated by reference herein in its entirety.

Further details on air hybrid engines are disclosed in U.S. Pat. No. 7,353,786 entitled Split-Cycle Air Hybrid Engine and issued on Apr. 8, 2008; U.S. Patent Application Ser. No. 61/365,343 entitled Split-Cycle Air Hybrid Engine and filed on Jul. 18, 2010; and U.S. Patent Application Ser. No. 61/313,831 entitled Split-Cycle Air Hybrid Engine and filed on Mar. 15, 2010, each of which is incorporated by reference herein in its entirety.

As the engines described above operate in the various air hybrid modes, inefficiencies arise when air being transferred to or from the air tank has a non-optimal temperature in relation to the engine's current operating mode. Accordingly, a need exists for improved air management systems and associated methods.

### SUMMARY

One advantage of air hybrid engines is the ability to generate compressed air while braking a vehicle which can be stored and used later to drive the vehicle. In this way, the energy that is usually wasted as friction and heat during vehicle braking by the foundation brakes can be transferred, stored, and used subsequently to save fuel consumption during vehicle accelerations and cruises. (Foundation brakes are the vehicle friction brakes used to decelerate and/or stop the vehicle, and are usually fitted to the wheels. These friction brakes convert the vehicle kinetic energy to waste heat and friction in the braking material and wheel hubs.)

As noted above, however, inefficiencies can result during air hybrid operation when the temperature of the air mass being transferred to and/or from the air storage medium is inappropriate for the current operating mode or conditions. In AC and FC modes, for example, transferring relatively warm air from the compression cylinder to the air tank increases the temperature within the air tank, thereby reducing the total air mass that can be stored in the air tank and increasing the energy required to achieve the transfer. In addition, storing relatively warm air in the air tank at a high pressure requires additional thermal insulation and can pose a number of safety concerns, especially if the air tank is damaged in a vehicle accident. In AE mode, transferring relatively cool air from the air tank into the expansion cylinder provides less expansion energy than warmer air would provide. Also, in AEF mode, transferring air that is too hot from the air tank to the expansion cylinder decreases the effective expansion ratio, reduces the amount of fuel that can be added to the combustion mixture, and decreases engine power.

The systems and methods disclosed herein generally involve air management systems for improving the efficiency of energy transfer from the air tank to the engine and vice versa. In one embodiment, the air management system includes a heat exchanger, a recuperator, and one or more control valves and is configured to modify, adjust, and/or regulate the temperature of air as it travels between the various components of the engine.

In one aspect of at least one embodiment of the invention, an air hybrid engine is provided that includes an air tank configured to store pressurized air and a heat exchanger operatively coupled to the air tank and to a cylinder of the engine, the heat exchanger being configured to selectively cool air as it is transferred from the cylinder to the air tank and being configured to selectively cool air as it is transferred from the air tank to the cylinder.

Related aspects of at least one embodiment of the invention provide an engine, e.g., as described above, that includes a recuperator operatively coupled to the air tank and to the cylinder of the engine, the recuperator being configured to selectively heat air as it is transferred from the air tank to the cylinder.

In another aspect of at least one embodiment of the invention, a split-cycle air hybrid engine is provided that includes a crankshaft rotatable about a crankshaft axis, a compression piston slidably received within a compression cylinder and operatively connected to the crankshaft such that the compression piston reciprocates through an intake stroke and a compression stroke during a single rotation of the crankshaft, and an expansion piston slidably received within an expansion cylinder and operatively connected to the crankshaft such that the expansion piston reciprocates through an expansion stroke and an exhaust stroke during a single rotation of the crankshaft. The engine also includes a crossover passage interconnecting the compression and expansion cylinders, the crossover passage including a crossover compression (XovrC) valve and a crossover expansion (XovrE) valve defining a pressure chamber therebetween and an air tank selectively operable to store compressed air from the compression cylinder and to deliver compressed air to the expansion cylinder. The engine also includes a heat exchanger operatively coupled to the air tank and the crossover passage via at least one control valve, the heat exchanger being configured to cool air moving from the crossover passage to the air tank and being configured to cool air moving from the air tank to the crossover passage.

Related aspects of at least one embodiment of the invention provide an engine, e.g., as described above, that includes a recuperator operatively coupled to the air tank and the crossover passage via the at least one control valve, the recuperator being configured to heat air moving from the air tank to the crossover passage.

Related aspects of at least one embodiment of the invention provide an engine, e.g., as described above, in which the recuperator is operatively coupled to an exhaust passage of the engine such that the recuperator is configured to transfer thermal energy from exhaust gasses generated by the engine to air moving from the air tank to the crossover passage.

Related aspects of at least one embodiment of the invention provide an engine, e.g., as described above, in which the heat exchanger uses at least one fluid selected from the group consisting of: engine coolant, ambient air, refrigerant, and working fluid of a vehicle air conditioning system.

Related aspects of at least one embodiment of the invention provide an engine, e.g., as described above, that includes at least one conduit through which fluid used by the heat exchanger to remove heat is transferred to the recuperator to add heat.

In another aspect of at least one embodiment of the invention, a method of operating a split-cycle air hybrid engine is provided that includes selectively cooling a first air mass as the first air mass is transferred from a crossover passage of the engine into an air tank of the engine by directing the first air mass through a heat exchanger. The method also includes selectively cooling a second air mass as the second air mass is transferred from the air tank into the crossover passage by directing the second air mass through the heat exchanger, and selectively heating a third air mass as the third air mass is transferred from the air tank into the crossover passage by directing the third air mass through a recuperator.

Related aspects of at least one embodiment of the invention provide a method, e.g., as described above, that includes transferring thermal energy from exhaust gasses generated by the engine to the third air mass as the third air mass passes through the recuperator.

Related aspects of at least one embodiment of the invention provide a method, e.g., as described above, that includes transferring thermal energy from the first air mass or the second air mass to a transfer fluid in the heat exchanger and subsequently transferring thermal energy from the transfer fluid to the third air mass in the recuperator.

Related aspects of at least one embodiment of the invention provide a method, e.g., as described above, in which the first air mass is cooled when the engine is operating in an AC mode and when the engine is operating in an FC mode.

Related aspects of at least one embodiment of the invention provide a method, e.g., as described above, in which the second air mass is cooled when the engine is operating in an AEF mode.

Related aspects of at least one embodiment of the invention provide a method, e.g., as described above, in which the third air mass is heated when the engine is operating in an AE mode.

In another aspect of at least one embodiment of the invention, an air hybrid engine is provided that includes an air tank configured to store pressurized air, and a heat exchanger operatively coupled to the air tank and to a cylinder of the engine, the heat exchanger being configured to cool air as it is transferred from the cylinder to the air tank and being configured to cool air as it is transferred from the air tank to the cylinder.

In another aspect of at least one embodiment of the invention, an air hybrid engine is provided that includes an air tank configured to store pressurized air, and a recuperator operatively coupled to the air tank, a cylinder of the engine, and an exhaust system of the engine, the recuperator being configured to retain heat from exhaust gasses flowing therethrough and to use said retained heat to heat air moving from the air tank to the crossover passage during at least an AE operating mode.

In another aspect of at least one embodiment of the invention, an air hybrid engine is provided that includes an air tank configured to store pressurized air and a recuperator operatively coupled to the air tank, a cylinder of the engine, and an exhaust system of the engine, the recuperator being configured to retain heat from exhaust gasses flowing therethrough and to use said retained heat to selectively heat air moving from the air tank to the crossover passage during at least an AE operating mode.

Related aspects of at least one embodiment of the invention provide an air hybrid engine, e.g., as described above, in which the recuperator is configured to heat air moving from the air tank to the crossover passage only during the AE operating mode.

Related aspects of at least one embodiment of the invention provide an air hybrid engine, e.g., as described above, in which the air tank is non-insulated.

Related aspects of at least one embodiment of the invention provide an air hybrid engine, e.g., as described above, in which the air tank includes one or more features to encourage cooling of air stored therein.

Related aspects of at least one embodiment of the invention provide an air hybrid engine, e.g., as described above, in which the air tank is formed from a material that comprises steel.

Related aspects of at least one embodiment of the invention provide an air hybrid engine, e.g., as described above, in which the air tank includes one or more heat sinks formed on or coupled to an interior surface thereof or an exterior surface thereof.

In another aspect of at least one embodiment of the invention, a split-cycle air hybrid engine is provided that includes a crankshaft rotatable about a crankshaft axis, a compression piston slidably received within a compression cylinder and operatively connected to the crankshaft such that the compression piston reciprocates through an intake stroke and a compression stroke during a single rotation of the crankshaft, and an expansion piston slidably received within an expansion cylinder and operatively connected to the crankshaft such that the expansion piston reciprocates through an expansion stroke and an exhaust stroke during a single rotation of the crankshaft. The engine also includes a crossover passage interconnecting the compression and expansion cylinders, the crossover passage including at least a crossover expansion (XovrE) valve, and an air tank selectively operable to store compressed air from the compression cylinder and to deliver compressed air to the expansion cylinder. The engine also includes a recuperator operatively coupled to the air tank and the crossover passage via at least one control valve, the recuperator being configured to retain heat from exhaust gasses flowing therethrough and to use said retained heat to heat air moving from the air tank to the crossover passage during at least an AE operating mode.

Related aspects of at least one embodiment of the invention provide a split-cycle air hybrid engine, e.g., as described above, in which the recuperator is operatively coupled to an exhaust passage of the engine such that the recuperator is configured to transfer thermal energy from exhaust gasses generated by the engine to air moving from the air tank to the crossover passage.

In another aspect of at least one embodiment of the invention, a method of operating a split-cycle air hybrid engine is provided that includes allowing a first air mass transferred from a crossover passage of the engine into an air tank of the engine to cool within the air tank, selectively supplying a second air mass of cooled air from the air tank to the crossover passage, and selectively heating a third air mass as the third air mass is transferred from the air tank into the crossover passage by directing the third air mass through a recuperator.

Related aspects of at least one embodiment of the invention provide a method, e.g., as described above, that includes transferring thermal energy from exhaust gasses generated by the engine to the recuperator when the engine is operating in any NF mode, FC mode, and AEF mode.

Related aspects of at least one embodiment of the invention provide a method, e.g., as described above, in which the second air mass is supplied to the crossover passage when the engine is operating in an AEF mode.

Related aspects of at least one embodiment of the invention provide a method, e.g., as described above, in which the third air mass is heated when the engine is operating in an AE mode.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1 is a schematic cross-sectional view of a prior art split-cycle air hybrid engine;

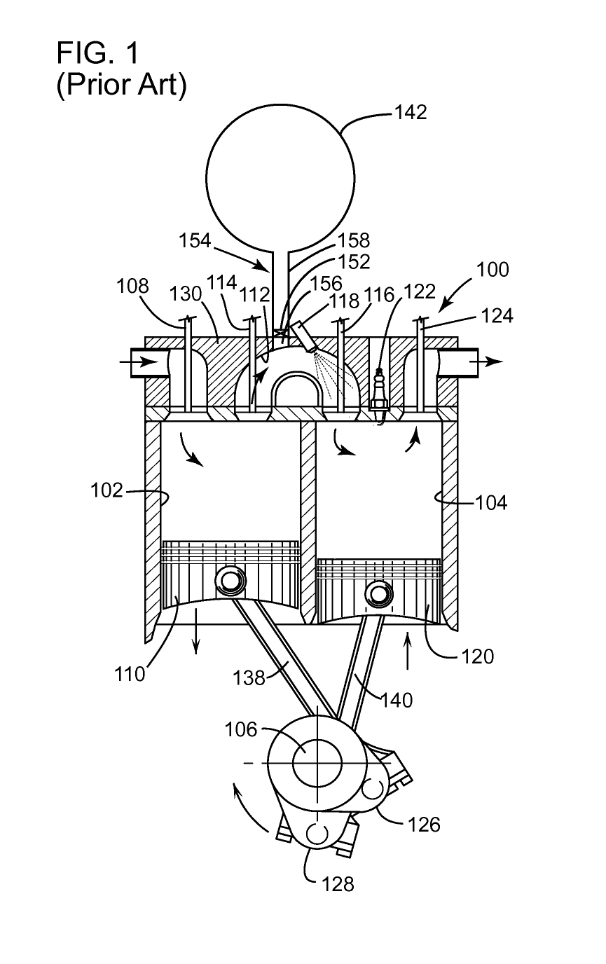

FIG. 2 is a schematic cross-sectional view of a split-cycle air hybrid engine according to one embodiment of the present invention;

FIG. 3 is a schematic cross-sectional view of a conventional air hybrid engine according to one embodiment of the present invention;

FIG. 4 is a schematic cross-sectional view of a split-cycle air hybrid engine according to another embodiment of the present invention;

FIG. 5 is schematic cross-sectional view of a conventional air hybrid engine according to another embodiment of the present invention; and

FIG. 6 is a schematic cross-sectional view of a split-cycle air hybrid engine according to another embodiment of the present invention.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The term “air” is used herein to refer both to air and mixtures of air and other substances such as fuel or exhaust products. The term “fluid” is used herein to refer to both liquids and gasses. Features shown in a particular figure that are the same as, or similar to, features shown in another figure are designated by like reference numerals.

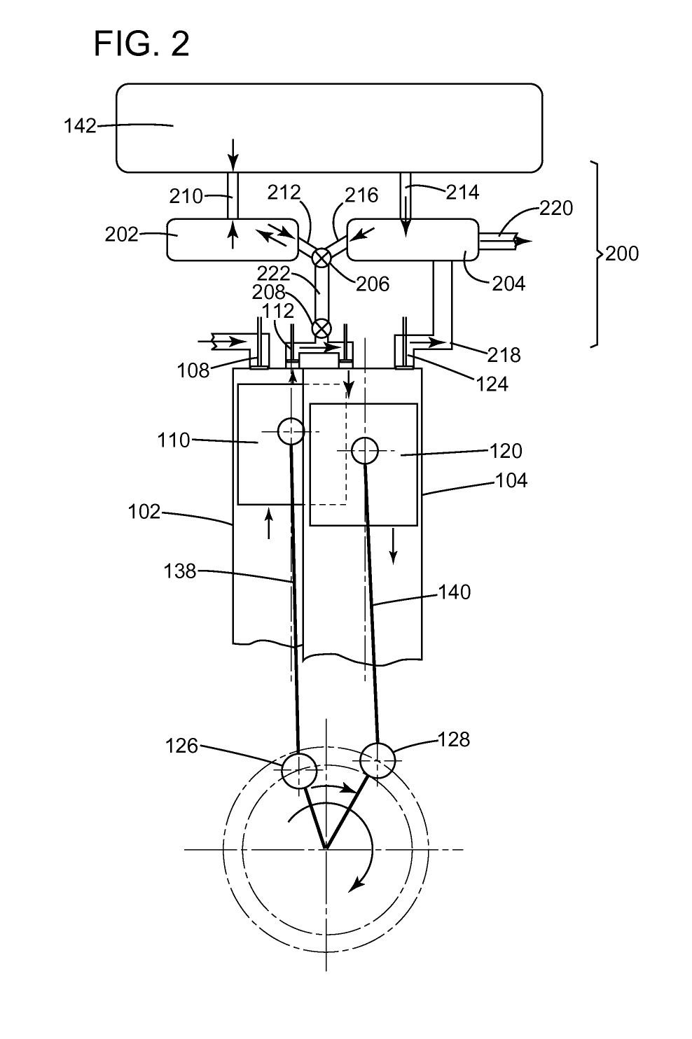

FIG. 2 illustrates a split-cycle engine that includes an air management system 200. The air management system 200 generally includes a heat exchanger 202, a recuperator 204, a first control valve 206, and a second control valve 208. It will be appreciated, however, that either the heat exchanger or the recuperator can be omitted from the air management system and that the air management system can have any number of control valves (e.g., zero, one, or two or more).

The heat exchanger 202 is configured to transfer heat from a warmer fluid to a cooler fluid, the fluids being separated by physical boundaries, and optionally being made to flow to and from the heat exchanger 202. Any of a variety of heat exchangers can be used in the air management system 200, including those that are mainly employed for continuous operation and have limited thermal capacity (e.g., those that depend on the continuous removal of heat by the cooler fluid and are not designed to store heat energy). The capacity of the heat exchanger 202 to transfer thermal energy is dictated in part by the surface areas over which the two fluids can exchange heat.

In the illustrated embodiment, the heat exchanger 202 is coupled to the air tank 142 via an exchanger-tank conduit 210 and to the first control valve 206 via an exchanger-engine conduit 212. Any of these conduits 210, 212 can include independent control valves configured to open, close, or alter the flow rate through the conduit. The heat exchanger 202 may use as its cooling fluid either ambient air, engine coolant, the fluid of a refrigeration or air conditioning system, or combinations thereof. The heat exchanger 202 can be of a conventional design such as those using pipes and fins.

The recuperator 204 is configured to store and transfer thermal energy from a fluid to a medium, which is typically fully contained within the recuperator 204 itself, the medium usually, but not always, being a solid of appreciable surface area and appreciable heat capacity. The recuperator 204 has a first operational mode in which it stores energy in the medium, the energy being transferred from a warmer fluid. The recuperator 204 also has a second operational mode in which it transfers energy stored in the medium to a cooler fluid. It will be appreciated that these operational modes can follow each other in succession, such that the recuperator 204 repeatedly alternates between being a hot source and a cold source. In certain embodiments, only a single fluid is used, so that the recuperator 204 is alternately adding and removing heat from the same fluid according to a particular operating mode of the engine. In such embodiments, the recuperator can also be referred to as a “regenerator.”

In the illustrated embodiment, the recuperator 204 is coupled to the air tank 142 via a recuperator-tank conduit 214, to the first control valve 206 via a recuperator-engine conduit 216, and to the engine's exhaust system via a recuperator-exhaust inlet conduit 218 and a recuperator-exhaust outlet conduit 220. Any of these conduits 214, 216, 218, 220 can include independent control valves configured to open, close, or alter the flow rate through the conduit. The recuperator 204 generally has added mass relative to the heat exchanger 202 to increase its thermal inertia. The recuperator 204 is formed from materials that are capable of withstanding the extreme temperatures and acidic fluids present in an engine exhaust environment, and can optionally be ceramic-coated or otherwise thermally-insulated. Exemplary materials for the recuperator 204 include stainless steel and cast iron.

The exchanger-engine conduit 212 and the recuperator-engine conduit 216 intersect at the first control valve 206, along with a crossover passage conduit 222. The first control valve 206 is configured to selectively place the crossover passage conduit 222 in fluid communication with the heat exchanger 202 and to selectively place the crossover passage conduit 222 in fluid communication with the recuperator 204. The crossover passage conduit 222 is also coupled to the crossover passage 112 of the engine via the second control valve 208, which is configured to selectively place the crossover passage 112 in fluid communication with the crossover passage conduit 222. It will be appreciated that, when closed, the second control valve 208 completely isolates the volumes of the various components and conduits of the air management system 200 from the volume of the crossover passage 112. This separation allows use of an air management system 200 in air hybrid operating modes while preserving the ability to achieve sonic flow from the crossover passage in normal firing mode and without undesirably reducing the effective compression ratio of the engine in normal firing mode.

The recuperator-exhaust inlet conduit 218 routes exhaust gasses generated by the engine into the recuperator 204, where thermal energy is transferred from the relatively warmer exhaust gasses to a relatively cooler air mass passing through the recuperator 204 from the air tank 142 to the crossover passage 112. The recuperator-exhaust outlet conduit 220 routes exhaust gasses out of the recuperator 204 and into the downstream portion of the engine's exhaust system (e.g., into turbochargers, collectors, catalysts, mufflers, and the like). In some embodiments, the recuperator-exhaust inlet conduit 218 can route exhaust gasses from downstream of a turbocharger or turbine into the recuperator 204, and the recuperator-exhaust outlet conduit 220 can route exhaust gasses out of the recuperator 204 further downstream in the engine's exhaust system.

The air management system 200 can also include a transfer conduit (not shown) and one or more associated control valves through which fluid used by the heat exchanger 202 to remove heat from an air mass can be routed to the recuperator 204 to add heat to the recuperator 204.

In operation, the engine operates in any of a variety of air hybrid modes, which can include the AE, AC, AEF, and FC modes described above. The heat exchanger 202 is selectively used, depending on the hybrid mode, to cool air travelling from the crossover passage 112 to the air tank 142 and/or to cool air travelling from the air tank 142 to the crossover passage 112. The recuperator 204 is selectively used, again depending on the hybrid mode, to heat air travelling from the air tank 142 to the crossover passage 112. As a result, the efficiency of the energy transfer to the air tank 142 by compressed air during the AC and FC modes is improved, as is the efficiency of the energy transfer from the air tank 142 by compressed air during the AE and AEF modes.

In AC and FC modes, the first control valve 206 is switched to route air that is compressed in the compression cylinder 102 into the heat exchanger 202 and then, after cooling, into the air tank 142. In this way, the density of the air in the air tank 142 can be increased to increase the stored mass of air, and the work required to push the air into the air tank 142 by the compression piston 110 can be reduced as the tank pressure will be lower for a given mass of contained air than would be the case with uncooled air, albeit with transfer of energy from the air to the heat exchanger cooling medium. In embodiments in which engine coolant is used as the cooling medium in the heat exchanger 202, the engine coolant temperature can be maintained during AC and FC modes. In other words, the heat exchanger 202 can prevent the engine coolant from dropping below a desired operating temperature, as could otherwise occur during modes in which there is no combustion. In each of the embodiments and operational modes discussed herein, the various control valves can be actuated under the control of an engine management system (e.g., a microprocessor that executes an engine management program stored in a memory).

In AEF mode, the first control valve 206 and the second control valve 208 are arranged so that compressed air from the air tank 142 returns through the heat exchanger 202 to be used for engine firing of the expansion cylinder 104, there being an advantage in having cooled air entering the expansion cylinder 104 since the cool air occupies a smaller volume and therefore allows an earlier closing of the XovrE valve, leading to an increase of the effective expansion ratio. It will be appreciated that, in some instances, the air stored in the air tank 142 will be cooler than the cooling fluid used in the heat exchanger 202. In such cases, one or more control valves (not shown) can be actuated to route the air from the air tank 142, through a bypass passage (not shown), and directly into the exchanger-engine conduit 212, without the air being passed through the heat exchanger 202. As a result, cooler air from the air tank 142 is not needlessly heated in the heat exchanger 202 when the heat exchanger temperature exceeds that of the air tank 142. Such conditions can be detected (e.g., using one or more temperature sensors disposed within the air tank and/or the heat exchanger) or predicted based on various engine operating parameters.

In AEF mode, the first control valve 206 and the second control valve 208 can also be arranged so that compressed air from the air tank 142 returns through the recuperator 204, particularly in certain low-load operating conditions. The recuperator 204, which will have been previously heated by exhaust flow through the recuperator-exhaust inlet 218 during a firing mode such as FC mode or AEF mode, heats the relatively cool compressed air from the air tank 142 by the thermal inertia of the recuperator 204. This is effective to increase the energy of the air before expanding and combusting it in the expansion cylinder 104. Heating the air charge from the air tank 142 in AEF mode can help maintain expansion cylinder pressure and help maintain sonic flow from the crossover passage 112. In addition, since only a relatively small amount of fuel is needed for combustion in low-load conditions, it is acceptable to heat the air charge before combustion.

In AE mode, the first control valve 206 is switched to allow compressed air from the air tank 142 to flow through the recuperator 204, which will have been previously heated by exhaust flow through the recuperator-exhaust inlet 218 during a firing mode such as FC mode or AEF mode. The relatively cool compressed air from the air tank 142 is heated by the thermal inertia of the recuperator 204, increasing the energy of the air before expanding it for useful work in the expansion cylinder 104.

It will thus be appreciated that, using the illustrated air management system 200, the efficiency of the engine can be increased by (1) reducing the work of compression and increasing the effective air tank capacity during AC and FC modes of operation, (2) improving the effective expansion ratio during AEF modes of operation, and (3) recovering otherwise wasted exhaust energy to increase the energy of the compressed air in AE modes of operation.

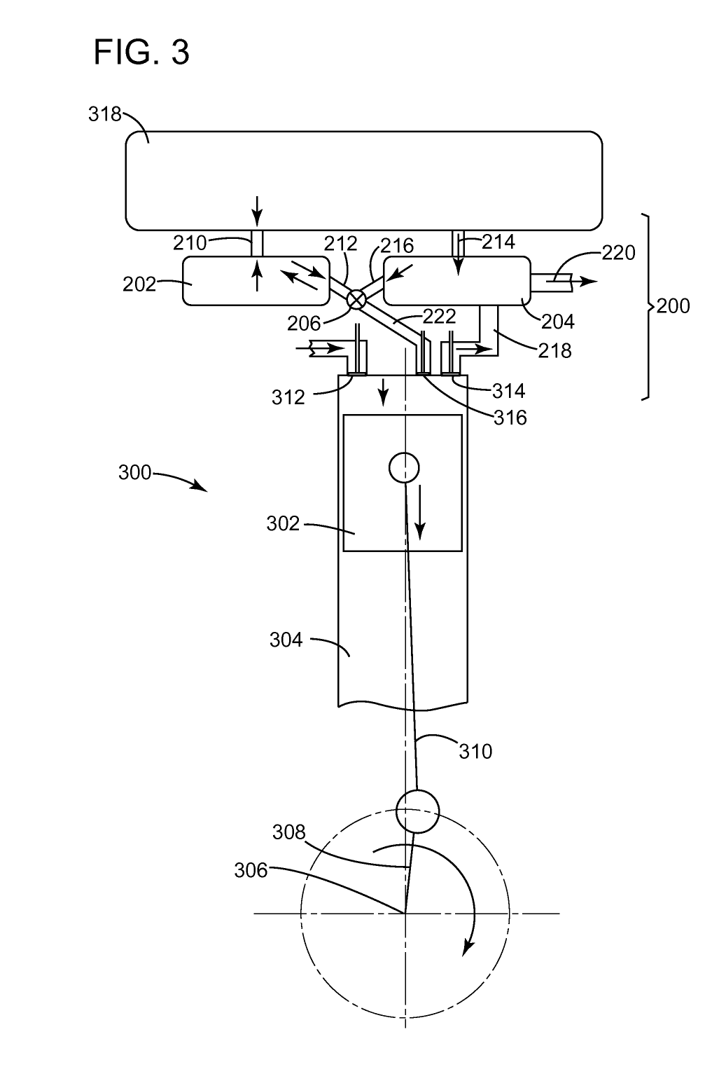

FIG. 3 illustrates a conventional air hybrid engine 300 having an air management system 200. The engine 300 includes a piston 302 reciprocally disposed within a cylinder 304. The piston 302 is coupled to a crankshaft 306 having a first crank throw 308 by a connecting rod 310 such that rotation of the crankshaft 306 is effective to reciprocate the piston 302. Air flow into and out of the cylinder 304 is controlled by an intake valve 312, an exhaust valve 314, and an auxiliary valve 316. The auxiliary valve 316 is configured to selectively place the combustion chamber of the cylinder 304 in fluid communication with the air management system 200, which is in turn coupled to an air tank 318. The auxiliary valve 316 can be actuated by any of a variety of systems, including hydraulic, pneumatic, electrical, or mechanical actuation systems. The air management system 200 is substantially as described above with respect to FIG. 2, except that the second control valve 208 is replaced with the auxiliary valve 316 and the crossover passage conduit 222 becomes a combustion chamber conduit 222.

In operation, the air induction, air compression, combustion and expansion, and exhausting of burnt products occurs over four successive strokes of the piston 302, the four strokes comprising two engine revolutions. This is in contrast to the split-cycle engines disclosed herein in which a first cylinder performs air induction and air compression over two successive strokes of the piston, i.e. one engine revolution, while a second cylinder simultaneously performs combustion and expansion over two successive strokes of the piston, i.e. one engine revolution, so that the split-cycle engine completes its four strokes in a single engine revolution.

The engine 300 can have a plurality of cylinders like the illustrated cylinder 304, each of which can temporarily and independently act in a normal firing mode, in an air compressor mode, or in an air expander mode. This is in contrast to the dedicated compression and expansion cylinders of a split-cycle engine.

In AC mode, the valve timing of the engine 300 is altered so that the cylinders of the engine temporarily behave as compressors without subsequent combustion. In FC mode, at least one cylinder of the engine 300 temporarily behaves as a compressor while at least one other cylinder operates in a firing mode, driving the at least one cylinder that is acting as a compressor.

In these AC and FC modes, the first control valve 206 and the auxiliary valve 316 are controlled such that air compressed in the cylinder 304 is routed into the heat exchanger 202 and then, after cooling, into the air tank 318. In this way, the density of the air in the air tank 318 can be increased to increase the stored mass of air, and the work required to push the air into the air tank 318 by the piston 302 can be reduced as the tank pressure will be lower for a given mass of contained air than would be the case with uncooled air, albeit with transfer of energy from the air to the heat exchanger cooling medium. In embodiments in which engine coolant is used as the cooling medium in the heat exchanger 202, the engine coolant temperature can be maintained during AC and FC modes.

In AEF mode, at least one cylinder of the engine 300 receives its air for combustion from the compressed air tank 318. In this mode, the first control valve 206 and the auxiliary valve 316 are arranged so that compressed air from the air tank 318 returns through the heat exchanger 202 to be used for engine firing of the cylinder 304, there being an advantage in having cooled air entering the cylinder 304 since the cool air occupies a smaller volume and therefore allows an earlier closing of the auxiliary valve 316, leading to an increase of the effective expansion ratio. It will be appreciated that, in some instances, the air stored in the air tank 318 will be cooler than the cooling fluid used in the heat exchanger 202. In such cases, one or more control valves (not shown) can be actuated to route the air from the air tank 318, through a bypass passage (not shown), and directly into the exchanger-engine conduit 212, without the air being passed through the heat exchanger 202. As a result, cooler air from the air tank 318 is not needlessly heated in the heat exchanger 202 when the heat exchanger temperature exceeds that of the air tank 318. Such conditions can be detected (e.g., using one or more temperature sensors disposed within the air tank and/or the heat exchanger) or predicted based on various engine operating parameters.

In AE mode, at least one cylinder of the engine 300 temporarily operates as an air expander with no combustion and receives its air from the compressed air tank 318. In this mode, the first control valve 206 is switched to allow compressed air from the air tank 318 to flow through the recuperator 204, which will have been previously heated by exhaust flow through the recuperator-exhaust inlet 218 during a firing mode such as FC mode or AEF mode. The relatively cool compressed air from the air tank 318 is heated by the thermal inertia of the recuperator 204, increasing the energy of the air before expanding it for useful work in the cylinder 304.

It will thus be appreciated that, using the illustrated air management system 200, the efficiency of the conventional air hybrid engine 300 can be increased by (1) reducing the work of compression and increasing the effective air tank capacity during AC and FC modes of operation, (2) improving the effective expansion ratio during AEF modes of operation, and (3) recovering otherwise wasted exhaust energy to increase the energy of the compressed air in AE modes of operation.

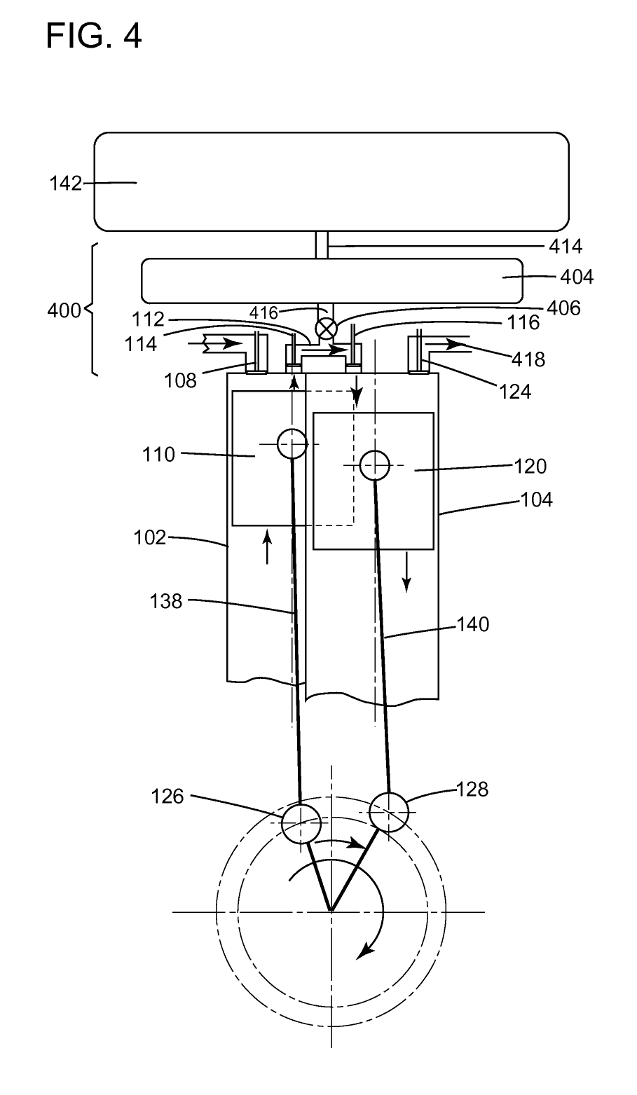

FIG. 4 illustrates an alternative embodiment of a split-cycle air hybrid engine having an air management system in which the heating and cooling functions are integrated into at least one recuperator. As shown, the air management system 400 includes a recuperator 404 that is operatively coupled to the air tank 142 via a recuperator-tank conduit 414. The recuperator 404 is also operatively coupled to a first control valve 406 via a recuperator-engine conduit 416. As shown, the recuperator 404 is not necessarily coupled to the engine's exhaust passage 418 in this embodiment.

In operation, the recuperator 404 is configured to selectively heat and/or cool air traveling from the air tank 142 to the crossover passage 112 and/or vice versa. In AC and FC modes, the first control valve 406 is switched to route compressed air from the compression cylinder 102 and the crossover passage 112 into the recuperator 404 and then into the air tank 142. The recuperator 404 is managed (e.g., using a cooling fluid such as engine coolant, ambient air, refrigerant, etc.) so that it is cooler than the compressed air at commencement of the movement of the compressed air from the compression cylinder 102 to the air tank 142. The recuperator 404 removes heat from the compressed air, but the recuperator temperature gradually rises so that its effective cooling capability relative to the compressed air diminishes until the recuperator 404 reaches the same temperature as the compressed air. In this way, the density of the air in the air tank 142 can be increased to increase the stored mass of air, and the work required to push air into the air tank 142 by the compression piston 110 can be reduced as the tank pressure will be lower for a given mass of contained air than would be the case with uncooled air.

In AE and AEF modes, the first control valve 406 is switched to route compressed air from the air tank 142 to the expansion cylinder 104 via the recuperator 404. The recuperator 404 is managed (e.g., using a heating fluid such as engine coolant, exhaust gasses, etc.) so that it is hotter than the compressed air at commencement of the movement of the compressed air from the tank 142 to the expansion cylinder 104. In some embodiments, the heating fluid used in AE and AEF modes can be the same fluid as the cooling fluid used in the AC and FC modes. In other words, the initially cool fluid that is heated by the compressed air in the AC and FC modes can then be used as heating fluid during the AE and AEF modes, such that the recuperator operates using a single fluid. Also, the recuperator can optionally be bypassed in AEF mode if cool air is required. The recuperator 404 adds heat to the compressed air, but the recuperator temperature gradually decreases such that its effective heating capability relative to the compressed air diminishes until the recuperator 404 reaches the same temperature as the compressed air.

In this embodiment, the heat of compression is alternately removed during the AC and FC modes to reduce compression work and therefore improve engine efficiency, and is subsequently added during the AE and AEF modes to increase expansion work and therefore improve engine efficiency. It will be appreciated that this embodiment is mechanically simpler than embodiments in which a separate heat exchanger is provided in addition to the recuperator.

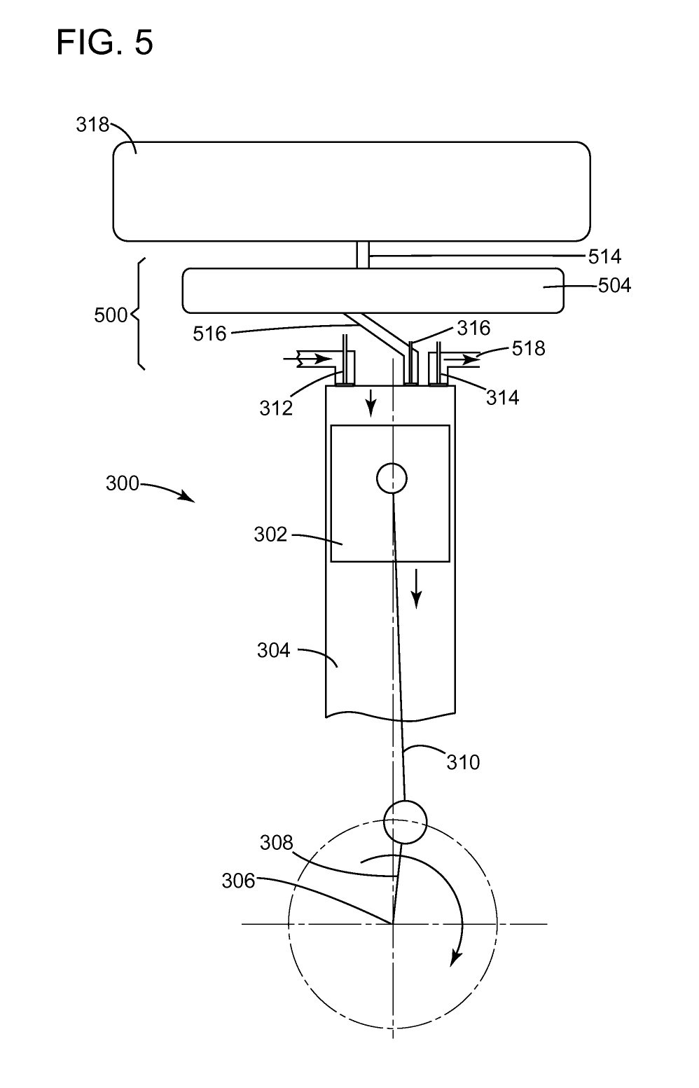

FIG. 5 illustrates an alternative embodiment of a conventional air hybrid engine having an air management system in which the heating and cooling functions are integrated into at least one recuperator. As shown, the air management system 500 includes a recuperator 504 that is operatively coupled to the air tank 318 via a recuperator-tank conduit 514. The recuperator 504 is also operatively coupled to the engine cylinder 304 via a recuperator-engine conduit 516 and an auxiliary valve 316. As shown, the recuperator 504 is not necessarily coupled to the engine's exhaust passage 518 in this embodiment.

In operation, the recuperator 504 is configured to selectively heat and/or cool air traveling from the air tank 318 to the engine cylinder 304 and/or vice versa. In AC and FC modes, the auxiliary valve 316 is opened to route compressed air from the cylinder 304, which is temporarily acting as a compressor, to the recuperator 504 and then into the air tank 318. The recuperator 504 is managed (e.g., using a cooling fluid such as engine coolant, ambient air, refrigerant, etc.) so that it is cooler than the compressed air at commencement of the movement of the compressed air from the cylinder 304 to the air tank 318. The recuperator 504 removes heat from the compressed air, but the recuperator temperature gradually rises so that its effective cooling capability relative to the compressed air diminishes until the recuperator 504 reaches the same temperature as the compressed air. In this way, the density of the air in the air tank 318 can be increased to increase the stored mass of air, and the work required to push air into the air tank 318 by the piston 302 can be reduced as the tank pressure will be lower for a given mass of contained air than would be the case with uncooled air.

In AE and AEF modes, the auxiliary valve 316 is opened to route compressed air from the air tank 318 to the cylinder 304, which is temporarily acting as an expander, via the recuperator 504. The recuperator 504 is managed (e.g., using a heating fluid such as engine coolant, exhaust gasses, etc.) so that it is hotter than the compressed air at commencement of the movement of the compressed air from the tank 318 to the cylinder 304. In some embodiments, the heating fluid used in AE and AEF modes can be the same fluid as the cooling fluid used in the AC and FC modes. In other words, the initially cool fluid that is heated by the compressed air in the AC and FC modes can then be used as heating fluid during the AE and AEF modes, such that the recuperator operates using a single fluid. Also, the recuperator can optionally be bypassed in AEF mode if cool air is required. The recuperator 504 adds heat to the compressed air, but the recuperator temperature gradually decreases such that its effective heating capability relative to the compressed air diminishes until the recuperator 504 reaches the same temperature as the compressed air.

In this embodiment, the heat of compression is alternately removed during the AC and FC modes to reduce compression work and therefore improve engine efficiency, and is subsequently added during the AE and AEF modes to increase expansion work and therefore improve engine efficiency. It will be appreciated that this embodiment is mechanically simpler than embodiments in which a separate heat exchanger is provided in addition to the recuperator.

It will be appreciated that there are other instances in which a separate heat exchanger is not necessarily required. For example, in some embodiments, the charge of air compressed in the compression cylinder is cool enough that there is no need for additional cooling before storing the air in the air tank. Also, the air tank can itself act as a heat exchanger in some embodiments, such as where a non-insulated tank is used, in which case there is no need for a separate heat exchanger.

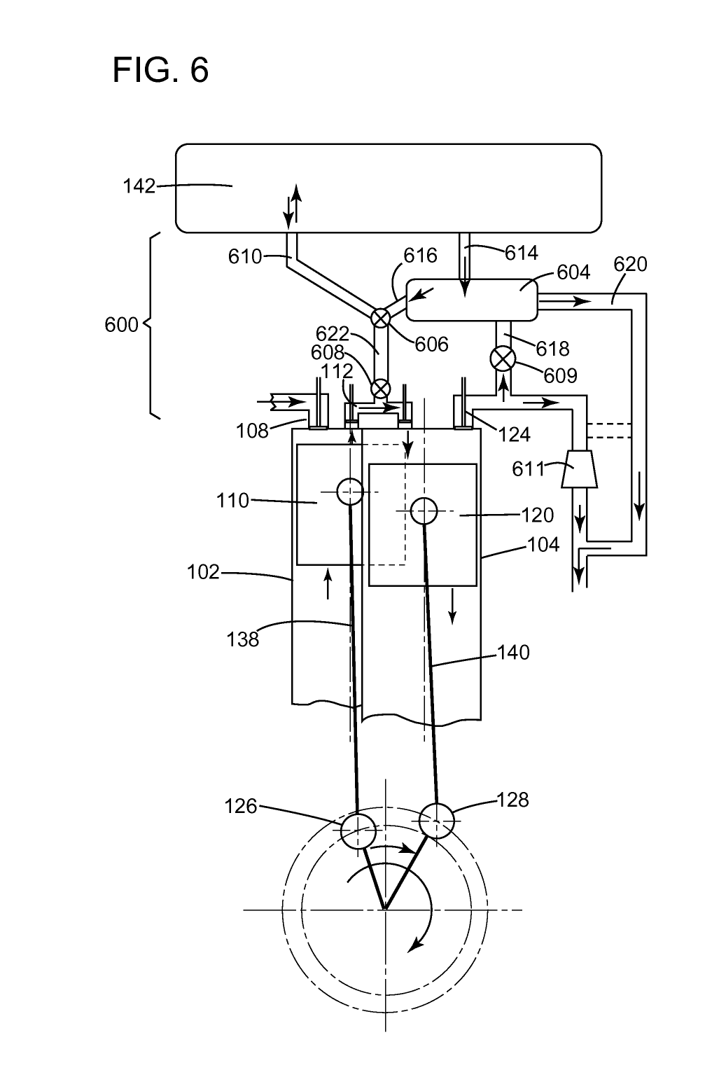

FIG. 6 illustrates a split-cycle engine that includes one exemplary embodiment of an air management system 600 in which a separate heat exchanger is not necessarily required. The air management system 600 generally includes a recuperator 604, a first control valve 606, a second control valve 608, and a third control valve 609. It will be appreciated, however, that the air management system can have any number of control valves (e.g., zero, one, two, or four or more).

In the illustrated embodiment, the air tank 142 is coupled to the first control valve 606 via a tank-engine conduit 610. The recuperator 604 is coupled to the air tank 142 via a recuperator-tank conduit 614, to the first control valve 606 via a recuperator-engine conduit 616, and to the engine's exhaust system via a recuperator-exhaust inlet conduit 618 and a recuperator-exhaust outlet conduit 620. The recuperator 604 can have a high thermal mass such that it is able to retain an appreciable amount of heat generated during prior operation in combustion modes (e.g., NF, FC, and AEF modes) during subsequent operation in non-combustion modes (e.g., AE mode). In some embodiments, the recuperator 604 can be maintained at a temperature of about 200 degrees C. to about 300 degrees C.

The tank-engine conduit 610 and the recuperator-engine conduit 616 intersect at the first control valve 606, along with a crossover passage conduit 622. The first control valve 606 is configured to selectively place the crossover passage conduit 622 in fluid communication with the air tank 142 and to selectively place the crossover passage conduit 622 in fluid communication with the recuperator 604. The crossover passage conduit 622 is also coupled to the crossover passage 112 of the engine via the second control valve 608, which is configured to selectively place the crossover passage 112 in fluid communication with the crossover passage conduit 622.

It will be appreciated that, when closed, the second control valve 608 completely isolates the volumes of the various components and conduits of the air management system 600 from the volume of the crossover passage 112. This separation allows use of an air management system 600 in air hybrid operating modes while preserving the ability to achieve sonic flow from the crossover passage 112 in normal firing mode and without undesirably reducing the effective compression ratio of the engine in normal firing mode.

The third control valve 609 is disposed in the recuperator-exhaust inlet conduit 618 and is configured to selectively prevent or allow flow of exhaust gasses into the recuperator 604. When the third control valve 609 is open, the recuperator-exhaust inlet conduit 618 routes at least a portion of the exhaust gasses generated by the engine into the recuperator 604, where thermal energy is transferred from the relatively warmer exhaust gasses to the thermal mass of the recuperator 604. This thermal energy can subsequently be transferred from the thermal mass of the recuperator 604 to a relatively cooler air mass passing through the recuperator 604 from the air tank 142 to the crossover passage 112. In the illustrated embodiment, when the third control valve 609 is open, some of the exhaust gasses still flow into a turbocharger 611 or other exhaust system components (e.g., collectors, catalysts, mufflers, and the like) without first flowing into the recuperator 604. It will be appreciated that in alternative embodiments, the air management system 600 can be configured such that when the third control valve 609 is open, substantially all of the exhaust gasses are routed through the recuperator 604 before flowing into the turbocharger 611 or other exhaust system components.

When the third control valve 609 is closed, exhaust gasses generated by the engine bypass the recuperator 604 and flow into the turbocharger 611 or other exhaust system components.

The recuperator-exhaust outlet conduit 620 routes exhaust gasses out of the recuperator 604 and into the downstream portion of the engine's exhaust system. In the embodiment of FIG. 6, the recuperator-exhaust outlet conduit 620 dumps exhaust gasses exiting the recuperator into a portion of the exhaust system that is downstream from the turbocharger 611. In some embodiments, however, the conduit 620 can instead supply exhaust gasses exiting the recuperator 604 into a portion of the exhaust system upstream from the turbocharger 611 (e.g., as shown with dashed lines in FIG. 6). In other words, the air management system 600 can also be configured to route engine exhaust gasses through both the recuperator 604 and the turbocharger 611. Any of the conduits 610, 614, 616, 618, 620, 622 can include one or more additional independent control valves configured to open, close, or alter the flow rate through the conduit. It will be appreciated that the turbocharger 611 is an optional component of the engine and can be omitted in some embodiments. In some embodiments, the recuperator-exhaust inlet conduit 618 can be relocated such that it routes exhaust gasses from downstream of the turbocharger 611 into the recuperator 604, and the recuperator-exhaust outlet conduit 620 can route exhaust gasses out of the recuperator 604 further downstream in the engine's exhaust system.

In operation, the engine operates in the NF mode and any of a variety of air hybrid modes, which can include the AE, AC, AEF, and FC modes described above. Air travelling from the crossover passage 112 to the air tank 142, and air stored in the air tank 142, is cooled due to thermal loss into the ambient air surrounding the conduits 610, 622 and the air tank 142. To enhance the cooling effect, the air tank 142 can be non-insulated and can be formed from a material that readily conducts heat to the surrounding atmosphere, such as steel. The air tank can also include one or more passive or active features to promote cooling of the air stored therein. For example, the air tank 142 can have a plurality of heat sinks formed thereon, can have a fan coupled thereto, can be positioned in proximity to a fan, and/or can be positioned within a vehicle such that air flows across the air tank's exterior when the vehicle is moving. The air tank can also include heat sinks or other features formed on or coupled to an interior thereof, such that heat can be extracted from compressed air stored in the air tank more efficiently. The recuperator 604 is selectively used, depending on the hybrid mode, to heat air travelling from the air tank 142 to the crossover passage 112. The air management system 600 can improve the efficiency of the energy transfer to the air tank 142 by compressed air during the AC and FC modes, and can improve the efficiency of the energy transfer from the air tank 142 by compressed air during the AE and AEF modes.

In AC mode, the first control valve 606 and the second control valve 608 are switched to route air that is compressed in the compression cylinder 102 into the air tank 142, where it is allowed to cool. In this way, the density of the air in the air tank 142 can be increased to increase the stored mass of air, and the work required to push the air into the air tank 142 by the compression piston 110 can be reduced as the tank pressure will be lower for a given mass of contained air than would be the case with an insulated air tank. During this time, the third control valve 609 can be closed to prevent air flowing out of the expansion cylinder (which is unheated due to the lack of combustion) from conducting heat away from the recuperator 604.

In FC mode, the first control valve 606 and the second control valve 608 are switched to route air that is compressed in the compression cylinder 102 into the air tank 142, where it is allowed to cool. In this way, the density of the air in the air tank 142 can be increased to increase the stored mass of air, and the work required to push the air into the air tank 142 by the compression piston 110 can be reduced as the tank pressure will be lower for a given mass of contained air than would be the case with an insulated air tank. During this time, the third control valve 609 can be opened to allow hot exhaust gasses generated during combustion to flow through the recuperator 604 and supply thermal energy thereto.

In AEF mode, the first control valve 606 and the second control valve 608 are configured so that compressed air from the air tank 142 returns through the tank-engine conduit 610 to be used for engine firing of the expansion cylinder 104, there being an advantage in having cooled air entering the expansion cylinder 104 since the cool air occupies a smaller volume and therefore allows an earlier closing of the XovrE valve, leading to an increase of the effective expansion ratio. During this time, the third control valve 609 can be opened to allow hot exhaust gasses generated during combustion to flow through the recuperator 604 and supply thermal energy thereto.

In AEF mode, the first control valve 606 and the second control valve 608 can also be configured so that compressed air from the air tank 142 returns through the recuperator 604, particularly in certain low-load operating conditions. The recuperator 604, which will have been previously heated by exhaust flow through the recuperator-exhaust inlet 618 during a firing mode such as FC mode or AEF mode, heats the relatively cool compressed air from the air tank 142 by the thermal inertia of the recuperator 604. This is effective to increase the energy of the air before expanding and combusting it in the expansion cylinder 104. Heating the air charge from the air tank 142 in AEF mode can help maintain expansion cylinder pressure and help maintain sonic flow from the crossover passage 112. In addition, since only a relatively small amount of fuel is needed for combustion in low-load conditions, it is acceptable to heat the air charge before combustion.

In AE mode, the first control valve 606 is switched to allow compressed air from the air tank 142 to flow through the recuperator 604, which will have been previously heated by exhaust flow through the recuperator-exhaust inlet 618 during a firing mode such as FC mode or AEF mode. The relatively cool compressed air from the air tank 142 is heated by the thermal inertia of the recuperator 604, increasing the energy of the air before expanding it for useful work in the expansion cylinder 104. During this time, the third control valve 609 can be closed to prevent air flowing out of the expansion cylinder (which is unheated due to the lack of combustion) from conducting heat away from the recuperator 604.

Accordingly, in the AE mode in which pressure of the stored air charge is relied upon to drive the expansion piston, the recuperator 604 can be used to increase the pressure of the air charge and thereby compensate for pressure previously lost when the air charge was cooled in the air tank 142. This recovery of exhaust gasses to generate heat and pressure for the expansion charge can referred to as a “bottoming cycle.” In some embodiments, the air management system 600 can be configured such that the recuperator is only used in AE mode.

It will thus be appreciated that, using the illustrated air management system 600, the efficiency of the engine can be increased by (1) reducing the work of compression and increasing the effective air tank capacity during AC and FC modes of operation, (2) improving the effective expansion ratio during AEF modes of operation, and (3) recovering otherwise wasted exhaust energy to increase the energy of the compressed air in AE modes of operation.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. An air hybrid engine, comprising:
an air tank configured to store pressurized air;
a heat exchanger operatively coupled to the air tank and to a cylinder of the engine, the heat exchanger being configured to selectively cool air as it is transferred from the cylinder to the air tank and being configured to selectively cool air as it is transferred from the air tank to the cylinder.

2. The air hybrid engine of claim 1, further comprising a recuperator operatively coupled to the air tank and to the cylinder of the engine, the recuperator being configured to selectively heat air as it is transferred from the air tank to the cylinder.

3. A split-cycle air hybrid engine, comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including a crossover compression (XovrC) valve and a crossover expansion (XovrE) valve defining a pressure chamber therebetween;
an air tank selectively operable to store compressed air from the compression cylinder and to deliver compressed air to the expansion cylinder; and
a heat exchanger operatively coupled to the air tank and the crossover passage via at least one control valve, the heat exchanger being configured to cool air moving from the crossover passage to the air tank and being configured to cool air moving from the air tank to the crossover passage.

4. The engine of claim 3, further comprising a recuperator operatively coupled to the air tank and the crossover passage via the at least one control valve, the recuperator being configured to heat air moving from the air tank to the crossover passage.

5. The engine of claim 4, wherein the recuperator is operatively coupled to an exhaust passage of the engine such that the recuperator is configured to transfer thermal energy from exhaust gasses generated by the engine to air moving from the air tank to the crossover passage.

6. The engine of claim 4, wherein the heat exchanger uses at least one fluid selected from the group consisting of: engine coolant, ambient air, refrigerant, and working fluid of a vehicle air conditioning system.

7. The engine of claim 4, further comprising at least one conduit through which fluid used by the heat exchanger to remove heat is transferred to the recuperator to add heat.

8. A method of operating a split-cycle air hybrid engine comprising:
selectively cooling a first air mass as the first air mass is transferred from a crossover passage of the engine into an air tank of the engine by directing the first air mass through a heat exchanger;
selectively cooling a second air mass as the second air mass is transferred from the air tank into the crossover passage by directing the second air mass through the heat exchanger; and
selectively heating a third air mass as the third air mass is transferred from the air tank into the crossover passage by directing the third air mass through a recuperator.

9. The method of claim 8, further comprising transferring thermal energy from exhaust gasses generated by the engine to the third air mass as the third air mass passes through the recuperator.

10. The method of claim 8, further comprising transferring thermal energy from the first air mass or the second air mass to a transfer fluid in the heat exchanger and subsequently transferring thermal energy from the transfer fluid to the third air mass in the recuperator.

11. The method of claim 8, wherein the first air mass is cooled when the engine is operating in an AC mode and when the engine is operating in an FC mode.

12. The method of claim 8, wherein the second air mass is cooled when the engine is operating in an AEF mode.

13. The method of claim 8, wherein the third air mass is heated when the engine is operating in an AE mode.

14. An air hybrid engine, comprising:
an air tank configured to store pressurized air; and
a heat exchanger operatively coupled to the air tank and to a cylinder of the engine, the heat exchanger being configured to cool air as it is transferred from the cylinder to the air tank and being configured to cool air as it is transferred from the air tank to the cylinder.

15. An air hybrid engine, comprising:
an air tank configured to store pressurized air;
a recuperator operatively coupled to the air tank, a cylinder of the engine, and an exhaust system of the engine, the recuperator being configured to retain heat from exhaust gasses flowing therethrough and to use said retained heat to heat air moving from the air tank to the crossover passage during at least an AE operating mode.

16. An air hybrid engine, comprising:
an air tank configured to store pressurized air;
a recuperator operatively coupled to the air tank, a cylinder of the engine, and an exhaust system of the engine, the recuperator being configured to retain heat from exhaust gasses flowing therethrough and to use said retained heat to selectively heat air moving from the air tank to the crossover passage during at least an AE operating mode.

17. The air hybrid engine of claim 16, wherein the recuperator is configured to heat air moving from the air tank to the crossover passage only during the AE operating mode.

18. The air hybrid engine of claim 16, wherein the air tank is non-insulated.

19. The air hybrid engine of claim 16, wherein the air tank includes one or more features to encourage cooling of air stored therein.

20. The air hybrid engine of claim 16, wherein the air tank is formed from a material that comprises steel.

21. The air hybrid engine of claim 16, wherein the air tank includes one or more heat sinks formed on or coupled to an interior surface thereof or an exterior surface thereof.

22. A split-cycle air hybrid engine, comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including at least a crossover expansion (XovrE) valve;
an air tank selectively operable to store compressed air from the compression cylinder and to deliver compressed air to the expansion cylinder; and
a recuperator operatively coupled to the air tank and the crossover passage via at least one control valve, the recuperator being configured to retain heat from exhaust gasses flowing therethrough and to use said retained heat to heat air moving from the air tank to the crossover passage during at least an AE operating mode.

23. The engine of claim 22, wherein the recuperator is operatively coupled to an exhaust passage of the engine such that the recuperator is configured to transfer thermal energy from exhaust gasses generated by the engine to air moving from the air tank to the crossover passage.

24. A method of operating a split-cycle air hybrid engine comprising: allowing a first air mass transferred from a crossover passage of the engine into an air tank of the engine to cool within the air tank;
selectively supplying a second air mass of cooled air from the air tank to the crossover passage; and
selectively heating a third air mass as the third air mass is transferred from the air tank into the crossover passage by directing the third air mass through a recuperator.

25. The method of claim 24, further comprising transferring thermal energy from exhaust gasses generated by the engine to the recuperator when the engine is operating in any of a NF mode, an FC mode, and an AEF mode.

26. The method of claim 24, wherein the second air mass is supplied to the crossover passage when the engine is operating in an AEF mode.

27. The method of claim 24, wherein the third air mass is heated when the engine is operating in an AE mode.
